(19) United States
(12) Patent Application Publication
(10) Pub. No.: US 2006/0222191 A1
(43) Pub. Date: Oct. 5, 2006

(54) Surround sound system

(76) Inventors: Wen-Chi Hung, Taipei Hsien (TW); An-Sheng Chang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/098,445

(22) Filed: Apr. 5, 2005

(51) Int. Cl. H04R 5/02; H04R 5/00

(52) U.S. Cl. 381/307; 381/18; 381/160; 381/19

(57) ABSTRACT

A surround sound system includes a pair of front speakers, a pair of surround speakers, a pair of reflective elements and a control unit. The front speakers are positioned in front of a listener location. The surround speakers are positioned in front of the listener location for outputting directed sound columns. The reflective elements are positioned in rear of the listener location for receiving the directed sound columns of the surround speakers and then reflecting to the listener location. The control unit is electrically connected to the front speakers and the surround speakers, thereby to delay output of forward sound signals of the front speakers.

### BACKGROUND OF THE INVENTION

1. Field of the Invention

The present invention relates to a surround sound system, and more particularly to a surround sound system, which can shorten lengths of signal wires, thereby to prevent impedance of the signal wires from being interfered and house decoration from being damaged.

2. Description of the Related Art

Recently, there are more and more consumers to install “home theater” in the house. No matter what kinds of “home theaters”, they each must provide signal wires extended from front to rear along two sides of the house for electrically connecting to rear surround speakers.

In general, the home theater with 5.1 channel sound effect (5.1 CH) including a main channel, a central channel, a rear surround channel and a super bass will become a standard equipment in mind of the consumer. However, the consumers increasingly respect the house decoration, but the house decoration may be damaged via extending the signal wires to the rear surround speakers of the home theater.

Furthermore, in order to enable amplifiers to drive the speakers, the signal wires and speaker wires must be extended to the amplifiers and the speakers. However, the lengths of the signal wires and the speaker wires will affect the quality of outputting sound. Although the wireless speakers are developed for raising the quality of outputting sound, the wireless speakers are more expensive than the general speakers using the signal wires and the speaker wires.

In other words, if the home theater with 5.1 channel sound effect (5.1 CH) is constructed by means of the wire connection, the house decoration will be damaged by extending the signal wires to the rear surround speakers of the home theater. Another, if the home theater is constructed by means of the wireless manner, the cost of the wireless speakers is too expensive.

In short, the excessive cost and the wires extending question need to be solved in the development of the home theater. Furthermore, the present invention has been accomplished to eliminate the aforesaid problem.

### SUMMARY OF THE INVENTION

It is therefore a principal object of the present invention to provide a surround sound system, which can obtain a rear sound effect without positioning surround speakers in rear of a listener location. Hence, it will not need to extend the signal wires to the rear of the listener location for shortening the lengths of the signal wires and preventing impedance of the signal wires from being interfered and house decoration from being damaged.

To achieve the above object, one feature of the present invention is provided for a surround sound system including a pair of front speakers, a pair of surround speakers, a pair of reflective elements and a control unit. The front speakers are positioned in front of a listener location. The surround speakers are positioned in front of the listener location for outputting directed sound columns. The reflective elements are positioned in rear of the listener location for receiving the directed sound columns of the surround speakers and then reflecting to the listener location. The control unit is electrically connected to the front speakers and the surround speakers, thereby to delay output of forward sound signals of the front speakers.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a schematic diagram illustrating a surround sound system of the present invention.

### DETAILED DESCRIPTION OF THE EMBODIMENTS

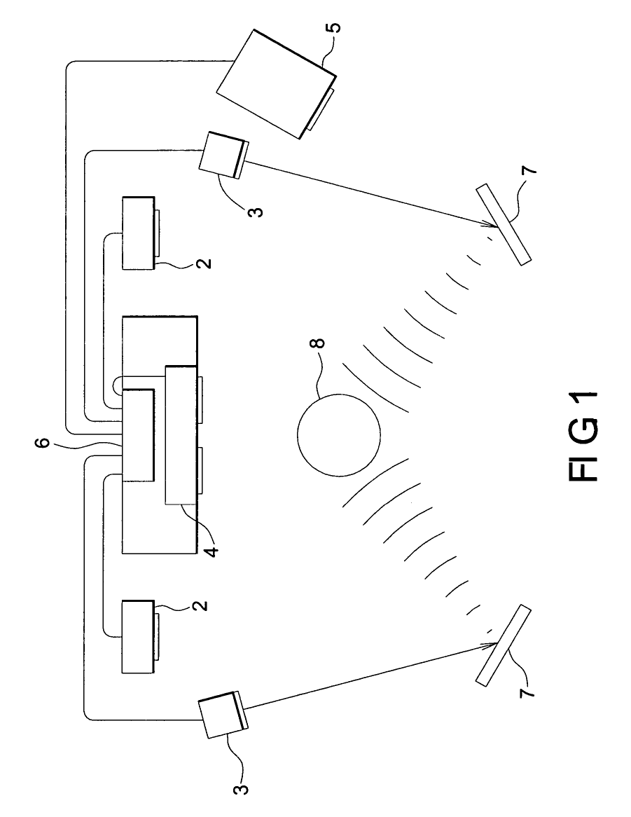

Referring now to the drawings wherein the showings are for purposes of illustrating preferred embodiments of the present invention only, and not for purposes of limiting the same. FIG. 1 is a schematic diagram illustrating a surround sound system of the present invention.

The present invention provides a surround sound system including at least one control unit, a plurality of speakers and a pair of reflective elements, thereby to produce a surround sound effect in a typical room. The listeners can enjoy a kind of feeling brought from the surround sound effect due to the present invention.

In general, the quadraphonic surround sound system with a basic surround sound effect includes a pair of front speakers and a pair of rear surround speakers. In the 4.1 channel surround sound system, it adds a super bass speaker at arbitrary place in the typical room with respect to the quadraphonic surround sound system. In the 5.1 channel surround sound system, it adds a central speaker at a front position in the typical room, perfect to face the listener, with respect to the 4.1 channel surround sound system, thereby to produce the better 5.1 channel surround sound effect.

With reference to FIG. 1, the surround sound system of the present invention includes a pair of front speakers 2, a pair of surround speakers 3, a central speaker 4, a super bass speaker 5, at least one control unit 6 and a pair of reflective element 7. The front speakers 2 are positioned at left and right sides in front of the listener location 8, respectively. The central speaker 4 is positioned in front of the listener location 8, perfect to face the listener. The super bass speaker 5 is positioned at arbitrary place in front of listener location 8. The surround speakers 3 are not positioned in rear of the listener location 8, but at the left and right sides in front of listener location 8. The surround speakers 3 are directed speakers for outputting directed sound columns and then reflecting to the listener location 8. The control unit 6 is electrically connected to the front speakers 2, the surround speakers 3, the central speaker 4 and the bass speaker 5, thereby to transmit sound signals into above speakers for outputting sound.

Accordingly, in the surround sound system of the present invention, the surround speakers 3 are positioned in front of the listener location 8, and their directed sound columns is directed to the reflective element 7 in rear of the listener location 8, hence the listener doesn't directly hear the directed sound columns outputted from the surround speakers 3. Furthermore, the directed sound columns are received and then reflected out by means of a sound scattering type for providing the listener's hearing. In other word, although the surround speakers 3 are positioned in front of the listener location 8, the rear sound outputting effect still can be achieved via reflecting of the directed sound columns from the reflective element 7.

However, after reflecting of the sound columns, the sound signals will be delayed to output. Thus, forward sound signals must be delayed for being synchronous to output of the delay sound signals. Therefore, the control unit 6 is provided for enabling the forward sound signals of the front speakers 2, the central speaker 4 and the bass speaker 5 are delayed to output, so that the sound signals of the surround speakers 3 can be synchronous with that of the other speakers for achieving the requirement of the 5.1 channel surround sound system.

Furthermore, the surround speakers 3 of the present invention are positioned in front of the listener location 8 to eliminate the conventional problem without extending signal wires to a rear of the listener location 8, thereby to shorten lengths of the signal wires.

In additional, the control unit 6 is operated via manual inputting distance data, or via automatic detecting distance data to obtain a corresponding delay time. The control unit 6 can be a controlling box, a computer for outputting the sound signals or making a delay control, or a controlling circuit for installing in one of the front speakers 2, the surround speakers 3 and the central speaker 4. The reflective elements 7 are reflective surfaces for reflecting the sound columns.

It is also believed that this new field of technology will become of greater significance with the evolution of the surround speakers technology. For example, the surround speakers of the present invention are positioned in front of the listener location, and then the sound columns of the surround speakers can be reflected from the reflective elements 7 in rear of the listener location, thereby to obtain the rear sound effect without positioning the surround speakers in rear of the listener location. Hence, it will not need to extend the signal wires to the rear of the listener location for shortening the lengths of the signal wires and preventing impedance of the signal wires from being interfered and house decoration from being damaged.

There has thus been described a new, novel and heretofore unobvious surround sound system which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A surround sound system, comprising:
a pair of front speakers positioned in front of a listener location;
a pair of surround speakers positioned in front of the listener location for outputting directed sound columns;
a pair of reflective elements positioned in rear of the listener location for receiving the directed sound columns of the surround speakers and then reflecting to the listener location;
a control unit electrically connected to the front speakers and the surround speakers, thereby to delay output of forward sound signals.

2. The surround sound system of claim 1, wherein the control unit is provided for delaying the output of the forward sound signals of the front speakers.

3. The surround sound system of claim 1, wherein the control unit is operated via manual inputting distance data to obtain a delay time.

4. The surround sound system of claim 1, wherein the control unit is operated via automatic detecting distance data to obtain a delay time.

5. The surround sound system of claim 1, wherein the control unit is a controlling box.

6. The surround sound system of claim 1, wherein the control unit is a computer.

7. The surround sound system of claim 1, wherein the control unit is a controlling circuit for installing in one of the front speakers and surround speakers.

8. The surround sound system of claim 1, wherein the reflective elements have reflective surfaces for reflecting the sound columns of the surround speakers.

9. The surround sound system of claim 1, further comprising a central speaker positioned between the pair of front speakers.

10. The surround sound system of claim 1, further comprising a bass speaker positioned in front of the listener location.
